(19) United States
(12) Patent Application Publication
(10) Pub. No.: US 2022/0036618 A1
(43) Pub. Date: Feb. 3, 2022

(54) ANIMATION PRODUCTION SYSTEM

(71) Applicant: AniCast RM Inc., Minato-ku (JP)

(72) Inventors: Yoshihito KONDOH, Chuo-ku (JP); Masato MUROHASHI, Tokyo (JP)

(21) Appl. No.: 17/007,964

(22) Filed: Aug. 31, 2020

(30) Foreign Application Priority Data
Jul. 29, 2020 (JP) 2020-128294

(51) Int. Cl. G06T 13/40

(52) U.S. Cl. CPC G06T 13/40

(57) ABSTRACT

To reduce the burden of animation production, an animation production system comprises a virtual camera that shoots a picture of a character placed in a virtual space; and an asset list that displays a list of assets available for the shooting in the virtual space, wherein the shooting is executed by applying an asset selected from the asset list to the virtual space.

### TECHNICAL FIELD

The present invention relates to an animation production system.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

In creating animations, assets (e. g. , character model data, audio data, music data, illustration data, etc.) are required, but it is very burdensome for the producer to create all the assets independently. On the other hand, if the creator searches out the necessary assets from time to time outside the virtual space on the Internet and downloads them for a fee or free and incorporates them into the animation being produced, the efficiency of animation production and the sense of immersion will be reduced.

The present invention has been made in view of this background, and is intended to provide a technology that can reduce the burden of animation production.

### Solution to Problem

The principal invention for solving the above-described problems is an animation production system comprising: a virtual camera for taking a character disposed in a virtual space; and an asset list for displaying a list of assets available for taking said photographs in said virtual space, wherein an asset selected from said asset list is applied to said virtual space for taking said photographs.

The other problems disclosed in the present application and the method for solving them are clarified in the sections and drawings of the embodiments of the invention.

### Advantageous Effects of Invention

According to the present invention, the burden of animation production can be reduced.

### BRIEF DESCRIPTION OF DRAWINGS

FIG. 1 is a diagram illustrating an example of a virtual space displayed on an HMD mounted by a user in an animation production system of the present embodiment.

FIG. 2 is a diagram illustrating an example of the overall configuration of an animation production system 300 according to an embodiment of the present invention.

FIG. 3 is a schematic view illustrating an appearance of an HMD 110 according to the present embodiment.

FIG. 4 is a diagram illustrating an example of a functional configuration of the HMD 110 according to the present embodiment.

FIG. 5 shows a schematic view of the appearance of the controller 210 according to the present embodiment.

FIG. 6 is a diagram illustrating an example of a functional configuration of a controller 210 according to the present embodiment.

FIG. 7 is a diagram illustrating an example of a functional configuration of an image producing device 310 according to the present embodiment.

FIG. 8 is a diagram illustrating a purchase of an asset from an asset list 6 in an animation production system 300 according to the present embodiment.

FIG. 9 is a diagram illustrating a purchase of an asset from an asset list 6 in an animation production system 300 according to the present embodiment.

FIG. 10 is a diagram illustrating a purchase of an asset from an asset list 6 in an animation production system 300 according to the present embodiment.

FIG. 11 is a diagram illustrating a purchase of an asset from an asset list 6 in an animation production system 300 according to the present embodiment.

### DESCRIPTION OF EMBODIMENTS

The contents of embodiments of the present invention will be described with reference. The present invention includes, for example, the following configurations.

### [Item 1]

An animation production system comprising:

a virtual camera that shoots a picture of a character placed in a virtual space; and

an asset list that displays a list of assets available for the shooting in the virtual space,

wherein the shooting is executed by applying an asset selected from the asset list to the virtual space.

### [Item 2]

The animation production system according to claim 1, wherein

the selected asset is used at cost.

### [Item 3]

The animation production system according to claim 1, wherein

the selected asset has a available time.

### [Item 4]

The animation production system according to claim 1, wherein

the assets in the asset list are provided by a server connected via a network.

### [Item 5]

The animation production system according to claim 1, wherein

the assets in the asset list are provided by other user.

### [Item 6]

The animation production system according to claim 1, wherein

an order in which the assets are displayed in the asset list is set according to a predetermined condition.

### [Item ]

The animation production system according to claim 1, wherein

an order in which the assets are displayed in the asset list is set in accordance with a history of transaction or rental.

### [Item 8]

The animation production system according to claim 1, wherein

the assets in the asset list is utilized at cost after the end of predetermined usage period.

### [Item 9]

The animation production system according to claim 1,

further comprising a virtual hand of a user in the virtual space,

wherein the asset from the asset list is extracted by the hand and used for the shooting by placing the asset in the virtual space.

A specific example of an animation production system 300 according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### <Overview>

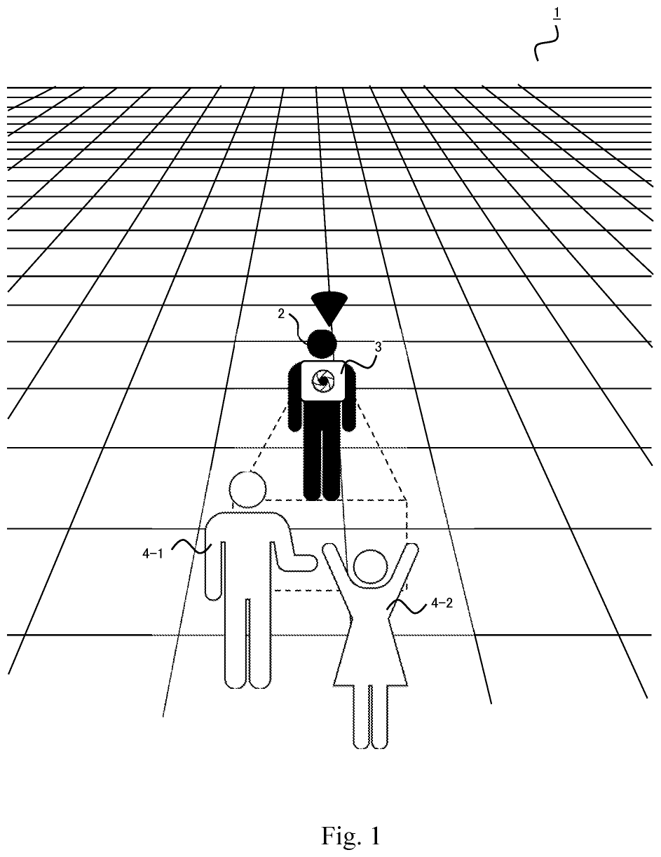

FIG. 1 is a diagram illustrating an example of a virtual space displayed on a head mount display (HMD) mounted by a user in an animation production system 300 according to the present embodiment. In the animation production system 300 of the present embodiment, a virtual character 4 and a virtual camera 3 are disposed in the virtual space 1, and a character 4 is shot using the camera 3. In the virtual space 1, a photographer 2 (a photographer character) is disposed, and the camera 3 is virtually operated by the photographer 2. In the animation production system 300 of this embodiment, as shown in FIG. 1, the user arranges the character 4 and the camera 3 while viewing the virtual space 1 from a bird's eye (Third Person's View), shoots the character 4 using the FPV (First Person View) as the photographer 2, and performs the performance of the character 4 using the FPV, while producing the animation. In the virtual space 1, a plurality of characters 4 (in the example of FIG. 1, characters 4-1 and 4-2) can be disposed, and the user can perform the performance while possessing a character 4. If more than one character 4 is disposed, the user may also switch the object possessed by each character 4 (e. g. , characters 4-1 and 4-2). That is, in the animation production system 300 of the present embodiment, one can play a number of roles (roles). In addition, since the camera 3 can be virtually operated as the photographer 2, natural camera work can be realized and the representation of the movie to be shot can be enriched.

### <General Configuration>

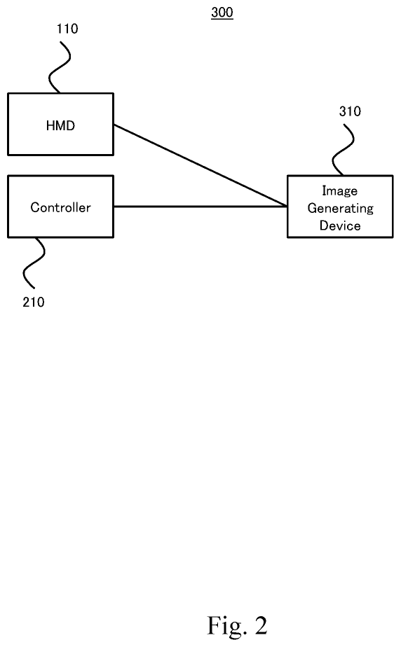

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. An infrared camera (not shown) or the like can also be added to the animation production system 300 for detecting the position, orientation and slope of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth (™), WiFi (™). The image generating device 310 may be a PC, a game machine, a portable communication terminal, or any other device having a calculation processing function.

### <HMD 110>

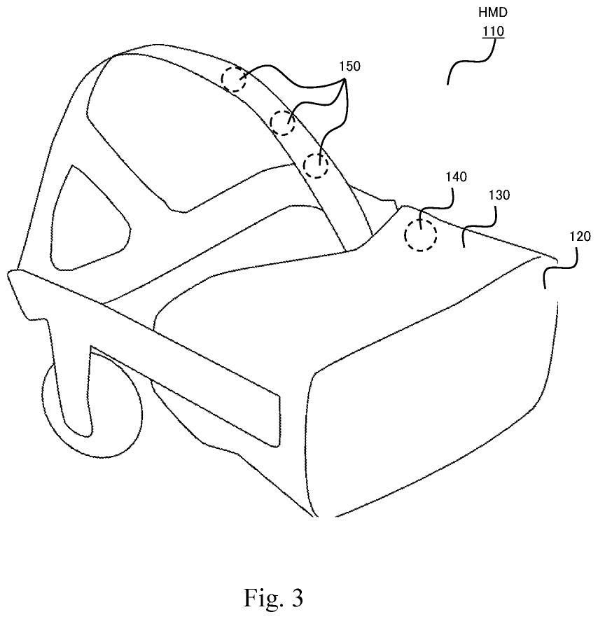

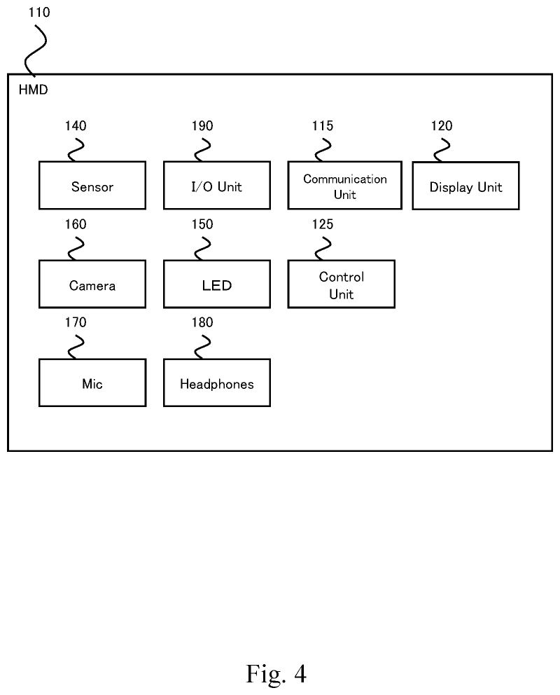

FIG. 3 shows a schematic view of the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although an optically transmissive and non-transmissive display is contemplated as the display panel, this embodiment illustrates a non-transmissive display panel that can provide more immersion. The display panel 120 displays a left-eye image and a right-eye image, which can provide the user with a three-dimensional image by utilizing the visual difference of both eyes. If left- and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e. g. , infrared light LEDs, visible light LEDs). A camera (e. g. , an infrared light camera, a visible light camera) installed outside the HMD 110 (e. g. , indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

### <Controller 210>

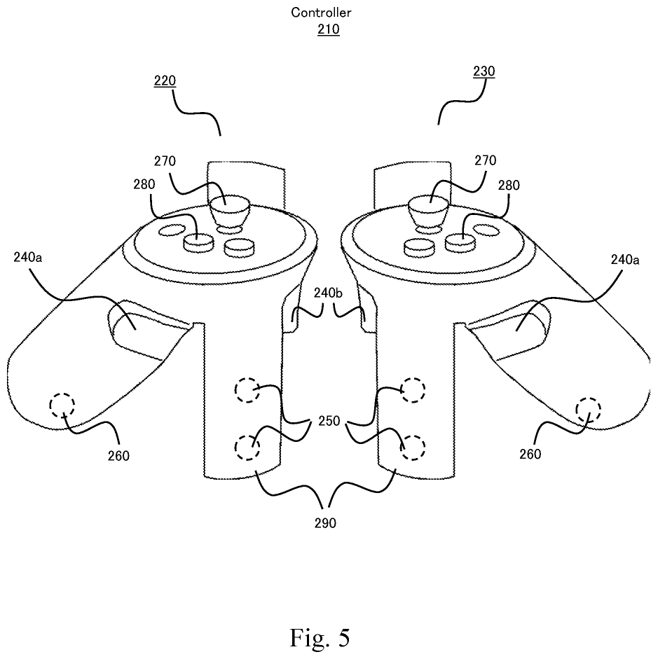

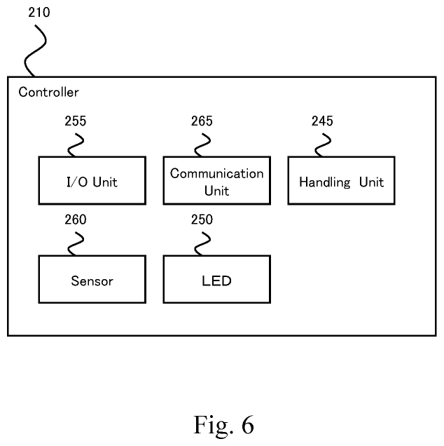

FIG. 5 shows a schematic view of the appearance of the controller 210 according to the present embodiment. FIG. 6 is a diagram illustrating an example of a functional configuration of a controller 210 according to this embodiment.

The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

### <Image Generator 310>

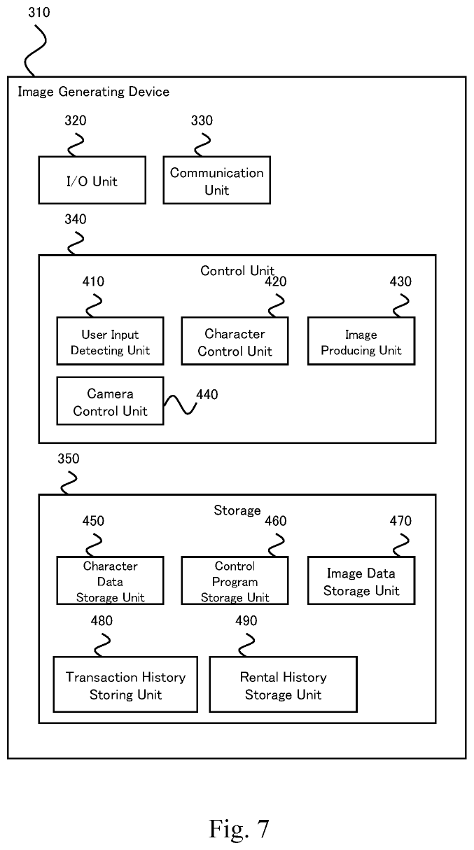

FIG. 7 is a diagram illustrating a functional configuration of an image producing device 310 according to the present embodiment. The image producing device 310 may use a device such as a PC, a game machine, a portable communication terminal, or the like, which has a function for storing information on the user's head movement or the movement or operation of the controller acquired by the user input information or the sensor, which is transmitted from the HMD 110 or the controller 210, performing a predetermined computational processing, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). The information received from the HMD 110 and/or the controller 210 regarding the movement of the user's head or the movement or operation of the controller is detected in the control unit 340 as input content including the operation of the user's position, line of sight, attitude, speech, operation, etc. through the I/O unit 320 and/or the communication unit 330, and a control program stored in the storage unit 350 is executed in accordance with the user's input content to perform a process such as controlling the character 4 and generating an image. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding the movement of the user's head, the user's speech, and the movement and operation of the controller, a character control unit 420 that executes a control program stored in the control program storage unit 460 for a character 4 stored in the character data storage unit 450 of the storage unit 350, a camera control unit 440 that controls a virtual camera 3 disposed in the virtual space 1 according to the character control, and an image producing unit 430 that generates an image in which the camera 3 captures the virtual space 1 based on the character control. Here, the movement of the character 4 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings for the camera 3 (for example, the position within the virtual space 1 of the camera 3, the viewing direction of the camera 3, the focus position, the zoom, etc.) depending on the movement of the hand of the character 4.

The storage unit 350 stores in the aforementioned character data storage unit 450 information related to the character 4, such as the attribute of the character 4, as well as the image data of the character 4. The control program storage unit 460 controls the operation and expression of the character 4 in the virtual space and stores a program for controlling an object such as the camera 3. The image data storage unit 470 stores the image generated by the image producing unit 430. The transaction history storing unit 480 stores the history of assets traded on the asset list (e. g. , date and time, contents, counterparty user, etc.). The rental history storage unit 490 stores the history of the assets rented on the asset list (e. g. , the date and time, the contents, the other party user, etc.).

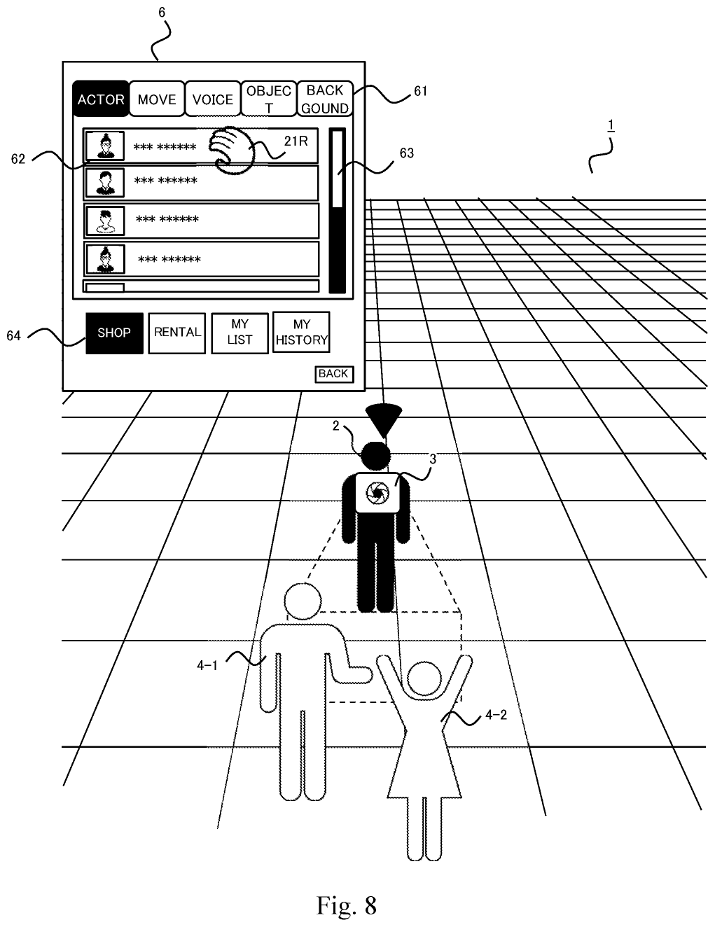

FIGS. 8-10 are diagrams illustrating a purchase etc. of an asset from the asset list 6 in the animation production system 300 according to this embodiment. The asset types, etc. included in the list of the sets of the present exemplary embodiments are not limited to those shown in FIG. 8, etc. , but may be configured to include one or more of them, or other parameter types may be included.

First, as shown in FIG. 8, the user opens the asset list 6 on the virtual space 1 and selects a character to be disposed, for example, as a character 4-3. The asset list 6 includes an asset type tab 61, an asset item 62, a scroll bar 63, and a button 64.

The asset type tab 61 may be, for example, a 3DCG model (ACTOR) of the character 4, an operational model (MOVE) of the character 4 (e. g. , shaking, pointing, double piece, etc.), a voice quality or a specific dialog (VOICE) when the character 4 is possessed, an object (OBJECT) that can be disposed in the virtual space 1, a background (BACK GROUND) that can be disposed in the virtual space 1, and the like. In addition, the 3DCG model of the character 4 may have a particular operation in advance.

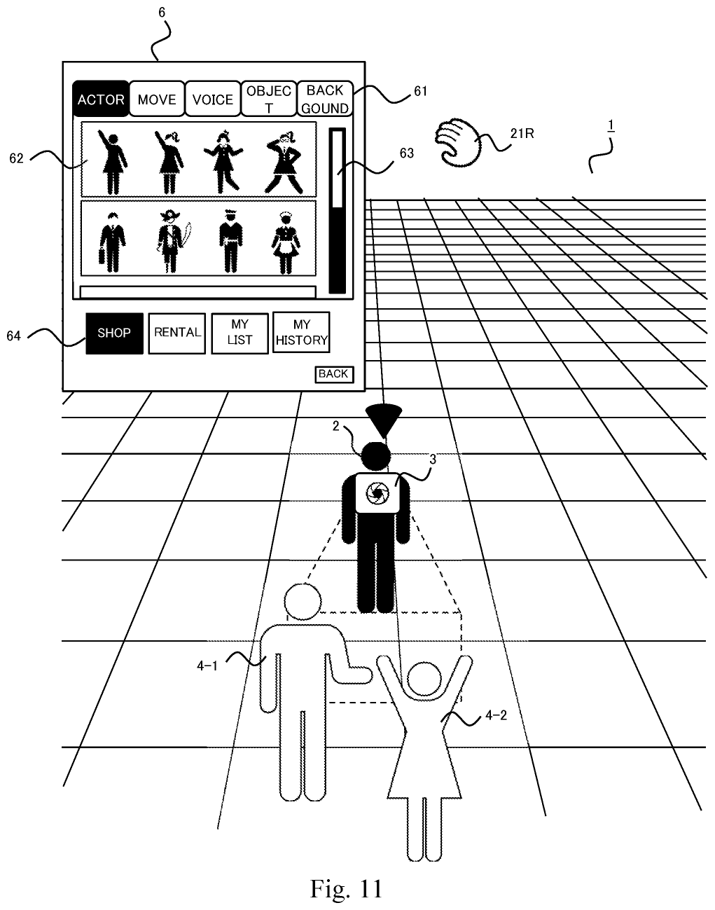

The asset item 62 is modified according to the selection of the asset type tab 61 to display a list corresponding to each type of asset. The items displayed in this list may be data obtained from a server connected via a network such as a cloud server, for example. In FIG. 8, a list of the 3DCG models of the purchaseable character 44 is illustrated and, as an example, the facial image and name are represented in each item, but not limited thereto, for example, the amount, setting age, and the like may be represented, or the 3DCG model may be represented as is, as shown in FIG. 11. In addition, when there are many display items, for example, a scroll bar 63 may be slid to allow all items to be identified, a sort such as the order of sound or the order of money may be possible, or the user's preferences may be learned based on the sales and rental history to preferentially display the assets in accordance with the user's preferences. Each item may be sold not only as a single asset but also as a set of assets of the same or different asset types.

Buttons 64 can be arranged for a variety of applications, and in FIG. 8 an example is an asset purchase button (SHOP), an asset rental button (RENTAL), a holding asset list (MY LIST), an asset purchase and/or rental history (MY HISTORY), and a button (BACK) that returns to the previous window display.

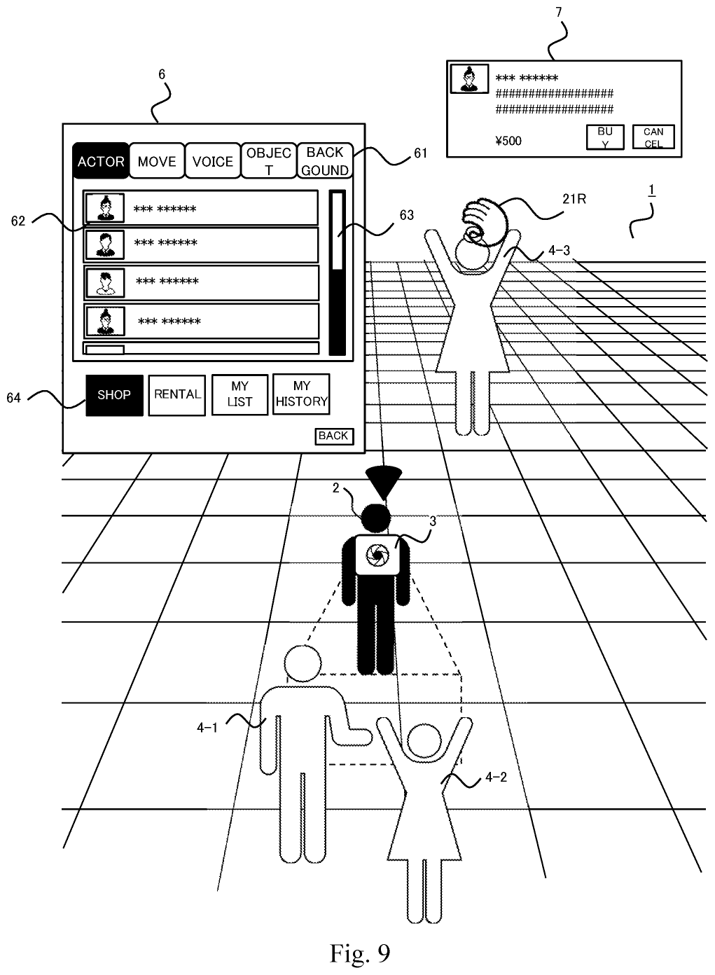

Next, as shown in FIG. 9, the user may grab on the selected asset item 62 by the virtual right hand 21R in the virtual space 1 and derive the 3DCG model of the character 4-3 therefrom. At this time, for example, the item data 7 (e. g. , details about the item, the amount at the time of purchase, etc.) may be displayed.

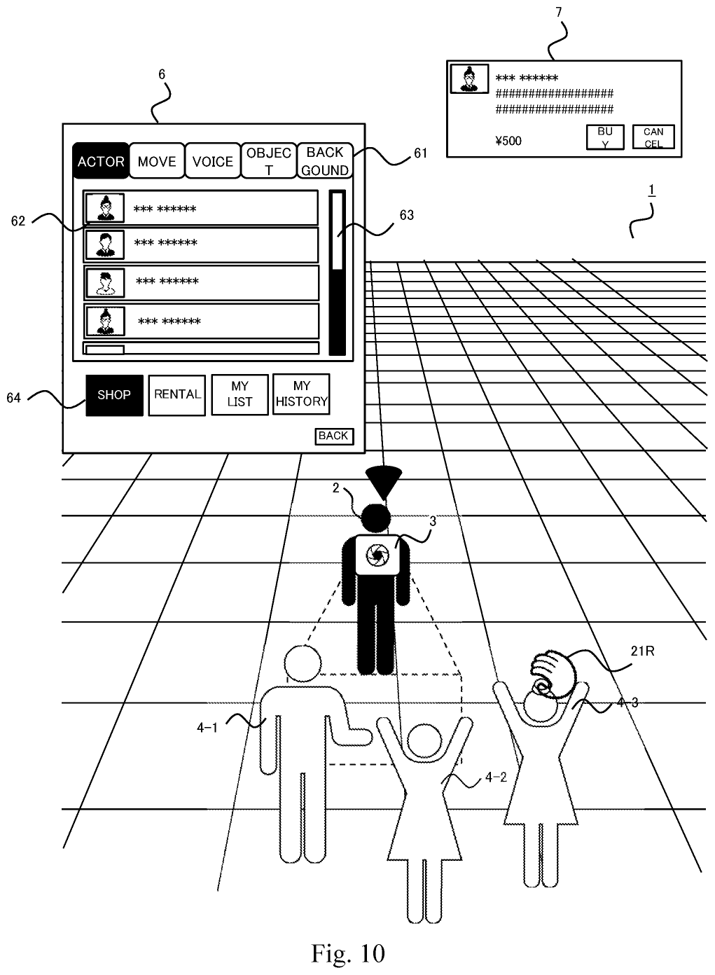

Then, as shown in FIG. 10, the character 4-3 drawn from the asset list 6 may be moved by the user while grasping the character 4-3, and a 3DCG model of the character 4-3 may be disposed on the virtual space 1, particularly within the imaging range. Although not shown, for example, when a user places a background image model in the virtual space 1, the user may grasp both ends of the pulled out background image model by the virtual right hand and left hand in the virtual space 1 to extend or reduce the background image model.

For example, after confirming the content of the item data 7, the purchase procedure may be performed by pressing the purchase decision button (BUY) on the item data 7 or the button to which the decision operation of the controller 210 has been assigned.

The timing of the purchase is not limited to the time point when it is applied within the virtual space 1 as described above. For example, a trial period for a predetermined period (e. g. , some seconds, some minutes, some hours, or some days) may be provided, and the existence or non-existence of the purchase may be subsequently selected. At this time, for example, when a character 4 or the like is disposed within the trial period, recording by the camera 3 may be restricted.

As described above, the purchase of assets has been described in accordance with FIGS. 8-10, but rental may also be substantially similar, except that the use period after payment is limited. Assets may also be utilized in a substantially similar manner to the method described in FIGS. 9-11 when using assets from a holding asset list or a purchase and/or rental history.

It is also possible to register the assets created by the producer in the asset list (MY LIST). The created assets can then be sold and/or rented for a fee or free to other unspecified number of users or designated users, and may be displayed in an assortment list of other users.

According to the animation production system 300 of the present embodiment, the user is intuitively able to locate the 3DCG model of the character 4-3, and the asset can be purchased in the virtual space 1 so that the asset can be readily prepared. In addition, the range of animated video representations is wider because the producer can purchase assets that could not be created by itself. Thus, it reduces the burden of animation production and provides a richer representation of animated video.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in the present embodiment, the image generating device 310 may be a single computer, but not limited to the HMD 110 or the controller 210 may be provided with all or some of the functions of the image generating device 310. It may also include a function of a portion of the image generating device 310 to other computers that are communicatively connected with the image generating device 310.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

### EXPLANATION OF SYMBOLS

1 virtual space

2 cameraman

3 cameras

4 characters

110 HMD

120 display panel

130 housing

140 sensor

150 light source

210 controller

220 left hand controller

230 right hand controller

235 grip

240 trigger button

250 Infrared LED

260 sensor

270 joystick

280 menu button

300 Animation Production System

310 Image Generator

320 I/O portion

330 communication section

340 controller

350 storage

410 User Input Detector

420 character control unit

430 Image Generator

440 Camera Control

450 character data storage section

460 Program Storage

470 Image Data Storage

1. An animation production system comprising:
a virtual camera that shoots a picture of a character placed in a virtual space; and
an asset list that displays a list of assets available for the shooting in the virtual space,
wherein the shooting is executed by applying an asset selected from the asset list to the virtual space, and
wherein when the asset being selected from the asset list, information regarding the selected asset is displayed in the virtual space.

2. The animation production system according to claim 1, wherein the selected asset is used at cost.

3. The animation production system according to claim 1, wherein
the selected asset has an available time.

4. The animation production system according to claim 1, wherein
the assets in the asset list are provided by a server connected via a network.

5. The animation production system according to claim 1, wherein
the assets in the asset list are provided by other user.

6. The animation production system according to claim 1, wherein
an order in which the assets are displayed in the asset list is set according to a predetermined condition.

7. The animation production system according to claim 1, wherein
an order in which the assets are displayed in the asset list is set in accordance with a history of transaction or rental.

8. The animation production system according to claim 1, wherein
the asset in the asset list is utilized at cost after an end of predetermined usage period.

9. The animation production system according to claim 1,
further comprising a virtual hand of a user in the virtual space,
wherein the asset from the asset list is extracted by the hand and used for the shooting by placing the asset in the virtual space.
